(19) United States
(12) Patent Application Publication
(10) Pub. No.: US 2007/0156365 A1
(43) Pub. Date: Jul. 5, 2007

(54) Method and system to define multiple metrology criteria for defect screening of electrical connections

(75) Inventor: Timothy E. Neary, Essex Junction, VT (US)

Correspondence Address: Steven Fischman, Esq.;Scully, Scott, Murphy & Presser, 400 Garden City Plaza, Garden City, NY, 11530, US

(73) Assignee: International Business Machines Corporation, Armonk, NY (US)

(21) Appl. No.: 11/325,785

(22) Filed: Jan. 5, 2006

(51) Int. Cl. G06F 17/30

(52) U.S. Cl. 702/117; 702/108

(57) ABSTRACT

A method and system for defining multiple metrological criteria for the screening of defects of electrical connections, such as controlled collapse chip connections (C4s). Moreover, the method and system defines the multiple metrology criteria or the defect screening of C4s in which the C4 minimum spacing in critical regions is measured at different criteria in comparison with criteria which is employed for more widely spaced apart C4s located in isolated areas.

### BACKGROUND OF THE INVENTION

1. Field of the Invention

The present invention relates to a method of and system for defining multiple metrological criteria for the screening of defects of controlled collapse chip connections (C4s). Moreover, the method pursuant to the invention defines the multiple metrology criteria or the defect screening of C4s in which the C4 minimum spacing in critical regions is measured at different criteria in comparison with criteria which is employed for more widely spaced apart C4s located in isolated areas.

At this time, the inspection of computer dies is provided in a commercially available mode, or through the application of randomly automated inspection systems, such as RVSIs, or PAS tools, as is known in the technology. In that instance, one aspect of the inspection of the C4 connects resides in the metrology or implementation of C4 size measurements, wherein output from the data, which is resultingly obtained is employed in the manufacturing process of the computer die. This aspect is also utilized to allow for inspection of C4 connects, which are located or arranged on the die. Also employed is a file which is adapted to locate all of the C4s and which generates a designation providing definitive information as to whether the individual C4s are essential or critical in nature or redundant, or as to whether they are provided for the emitting of an electrical signal or, alternatively, constitute a ground connection. Currently, no metrology criteria is available in the technology which pertains to the criticality in the proximity of the C4 connects relative to each other, besides their x, y locations. This kind of data, as is presently available, is only adapted to enable an identification of the die locations so that they can be inspected under single metrology criteria.

Although considerable art is currently available in connection with this technology, it does not provide a clear and definitive method in the employment of multiple metrology criteria for the defect screening of connections, such as C4 connections, and in the capability of providing any indication as to whether any of the individual C4s are critical in nature or redundant, and interrogated as to the purpose of the C4 connect utilizations, in effect, whether they are employed to provide electrical signals or constituting ground connections.

2. Discussion of the Prior Art

Ganz, et al., U.S. Patent Application Publication No. 2004/0062686 A1 is directed to the provision of a computer control pass-fail determination technique in which individual spots are determined for pass or fail predicated on several criteria and wherein a camera system scans a region to look for a specific spot. This particular publication is a surface imaging system, which does not employ multiple metrology criteria for the analysis and product disposition, such as in connection with a defect screening of C4 connections.

Duvdevani, et al., U.S. Patent Application Publication No. 2004/0126005 A1 relates to apparatus and methods for the inspection of objects, including creating a reference image which pertains to an at least partially vectorized first representation of boundaries within a range and acquiring an image of the object under inspection comprising a second representation of boundaries within the image. This particular aspect is directed to a circuit analysis comparison which fails to consider any multiple metrology criteria for the analysis and product disposition, particularly such as for the defect screening of C4 connecting.

Aiger, U.S. Patent Application Publication No. 2003/0174877 A1 is directed to the provision of a method for inspecting patterns of electrical circuitry, including the implementation of an initial inspection of a sequentially acquired image of an electrical circuit pattern, in order to determine potential defects in the electrical circuit pattern. In that instance, the circuit pattern is subjected to a two-dimensional inspection which does not in any manner concern itself with multiple metrology criteria for the disposition of a product, such as determining the defect screening of C4 connections.

Mueller, et al., U.S. Patent Application Publication No. 2003/0113009 A1 pertains to a system and method for confirming electrical connection defects which are encountered on printed circuit boards and applies a localized investigative routine, which are implemented upon portions of a printed circuit board having one or more identified defects. This circuit analysis comparison system of the publication does not in any manner consider multiple metrology criteria for the analysis and product disposition in the defect screening of C4 interconnections.

Roder, U.S. Patent Application Publication No. 2003/0035576 A1 relates to an automatic x-ray determination of the integrity of solder joints and the viewing of Delta Z values from a laser mapped reference surface for printed circuit board inspections. The x-ray and height measurements methods employed in this publication define a Z plane in a printed circuit board and do not consider multiple metrology criteria for analysis and product disposition, the latter of which is utilized in the defect screening of C4 connections pursuant to the present invention.

Roder, U.S. Pat. No. 6,490,368 B2 and Roder, U.S. Pat. No. 6,314,201 B1 are each similar to the previously discussed Roder, U.S. Publication No. 2003/0035576 A1, and also fails to disclose multiple metrology criteria for the analysis and product disposition in determining defect screening of C4 interconnections.

Cummings, et al., U.S. Pat. No. 6,429,390 B1 relates to a structure and method for forming electrical grid patterns on a printed wiring board having built-in inspection aids, and defines multiple inspection features in configurations allowing differentiation by visual inspection. This publication does not address itself to the inspection of features, which utilize different metrology criteria for analysis and disposition in the defect screening of C4 connections.

Finally, International Application PCT/US98/13303 (WO 99/00661) is directed to an inspection apparatus which collects two-dimensional and three-dimensional information pertaining to the inspection of a workpiece. There is no disclosure of employing multiple metrology criteria for the analysis and disposition of a product, such as provided for in the defect screening of C4 connections.

### SUMMARY OF THE INVENTION

Accordingly, none of the prior art publications currently known direct themselves to the present invention, the latter of which utilizes diverse multiple metrology criteria in the inspection of products. Hereby, in order to clearly and unambiguously distinguish over the current state of the technology, pursuant to the invention there is provided a novel method which utilizes a multiple metrology criteria for the defect screening of C4 connections, wherein the closest and most adjacent located C4 connections may be considered within the different metrology criteria limits. For instance, for critical tightly disposed C4 connections, which are located within the minimum allowed separation distances from each other, these C4 connections are adapted to be inspected by one metrology criteria with regard to respectively, their height, volume and diameter, whereas other C4 connections, which are located outside of the critical spacing criteria between adjacent C4 connections, may be inspected under metrology criteria which are within looser or broader bounds. Consequently, the inventive method facilitates the inspection, which may permit the employment of from two (2) different metrology criteria up to “n” numbers of different metrology criteria which are each dependent upon the relative positioning and locations of the C4s.

In essence, pursuant to the invention, in the employment of multiple metrology criteria, a location of all C4s relative to their closest adjacent C4 connections is computed predicated on a defined critical dimension. This critical dimension is the minimum spacing which is permitted for a particular design or C4 pattern, and is guaranteed to be maintained as required. Each C4 has a hypothetical box drawn thereabout at a+/−D (minimum) spacing. Consequently, any C4, the location of which falls within this particular box is identified as being critically spaced and is subject to the particular criteria for metrology deemed to be appropriate for that particular C4 (or solder bump) spacing. Consequently, if the closest positioned C4 is imparted from this designation, then the original starting die is also resultingly designated as being critically spaced. However, contrastingly, C4s which are located externally of the boundaries of this box are considered not to be critically spaced and are subject to different, possibly less stringent, metrology criteria. Consequently, for every expanding hypothetical box sizes, when pursuant to the invention there are provided multiple sets of metrology criteria, it is also possible to define a hypothetical circle rather than a box within the same metrology criteria employed for critical spacing of C4 connection defect screening purposes.

Accordingly, it is an object of the present invention to provide a method which is adapted for a multiple metrology criteria for the defect screening of controlled collapse chip connections.

Another more specific object of the present invention resides in providing a method of multiple metrology criteria as described in which C4 connections minimum spacing in critical regions is measured at different criteria in comparison with metrology criteria utilized for non-critical regions.

### BRIEF DESCRIPTION OF THE DRAWINGS

Reference may now be made to the following detailed description of a preferred embodiment of the invention, taken in conjunction with the accompanying drawings; in which:

FIG. 1 illustrates, in a plan view, a diagrammatic representation of C4 interconnects and pods arranged on a printed circuit board;

FIG. 2 illustrates an enlarged view of a first critical area for employing a first metrology criteria in the defect screening of C4 connections;

FIGS. 3A and 3B illustrate details of further views defining a non-critical area;

FIG. 4 illustrates a process flow chart in accordance with the prior art;

FIG. 5 illustrates a process flow chart pursuant to the present invention; and

FIG. 6 illustrates a performance graph showing C4 spacing as a function of volume.

### DETAILED DESCRIPTION OF THE INVENTION

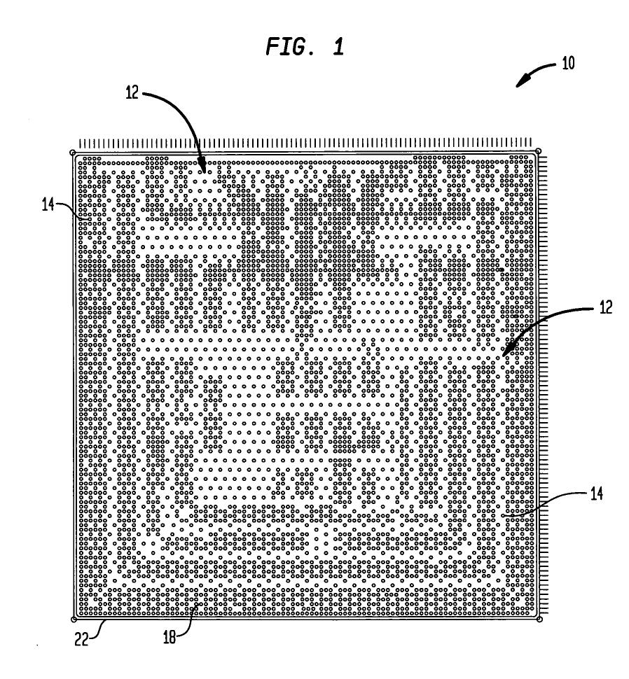

Referring in detail to the drawings, and particularly FIGS. 1, 2, 3A and 3B, there are indicated various areas of interest in implementing the multiple metrology criteria methods.

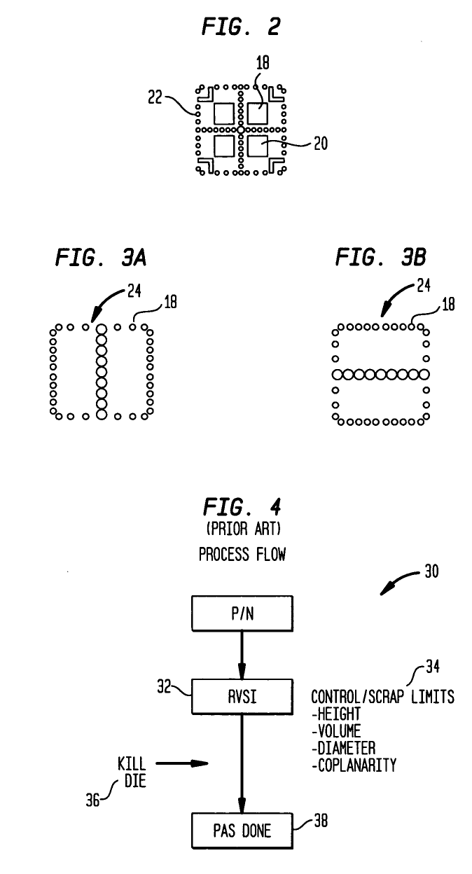

In particular, in FIG. 1 there is shown a circuit board 10, possessing areas 12 which illustrate groupings 14 of minimum spaced C4s 18 (or pads), which are to be subjected to a first metrology criteria, as for FIG. 2, for defect screening pursuant to a first and rigid metrology. Another critically spaced grouping of C4 connections (or pads) 20 may be ascertained in other areas 22 on the circuit board 10.

A further area 24, showing widely or more widely spaced C4s 18 (or pads), which are considered to be widely isolated, may be found among other such areas, as in FIGS. 3A and 3B, and wherein any electrical shorting to a closely spaced C4 would be highly unlikely. Consequently, in those instances, multiple sets of metrology criteria may be applied at a minimum of criteria to the C4s 18. Such widely isolated areas may be screened for C4 defects using looser criteria.

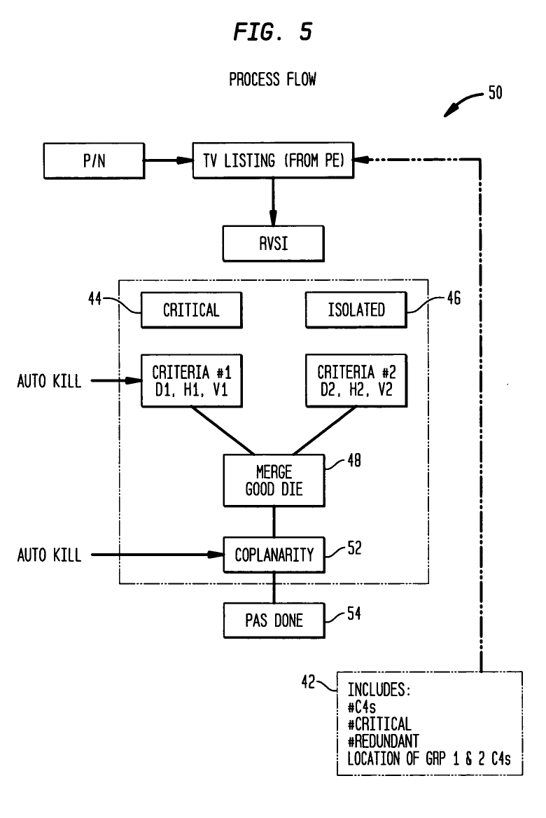

In the state-of-the-art, as shown in FIG. 4 of the drawings, a flow diagram 30 showing the numbers of pads or C4s 18 to the RVSI control in Box 32 disclose scrap limits 34 determined by a single metrology criteria as to height, volume, diameter and coplanarity. A kill die 36 signifies defective C4s or pads, whereupon the process is complete as in box 38.

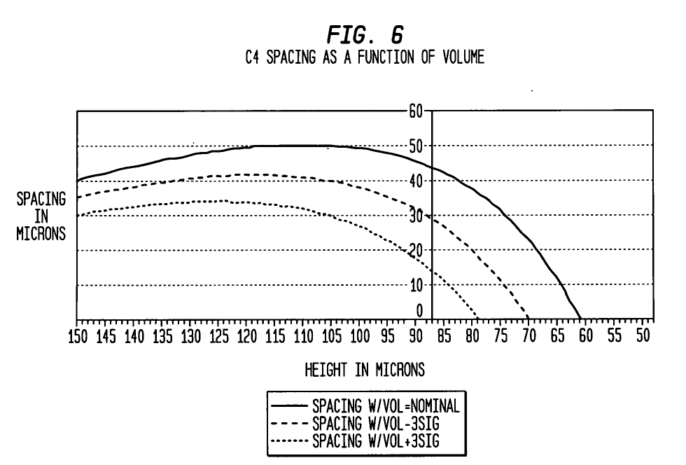

To the contrary, as shown by the present process flow diagram 50, as in FIG. 5, this includes initially (Box 42) the C4s of critical areas and redundant locations of the grouping from FIG. 1. These are separated into groupings (Box 44) wherein the critically closely spaced C4s are screened for density (D₁), height (H₁) and volume (V₁) at a first metrology criteria, and defective C4s are subjected to an automatic kill.

In a further separated state (Box 46), there is provided an automatic kill ratio pursuant to a second metrology criteria utilized for the isolated or widely spaced C4 connections, these are screened for density (D₂), height (H₂) and volume (V₂) in a similar process step.

The good dies containing the satisfactory C4s are then merged (Box 48) and coplanarity (Box 52) of the C4s or pads 18 is investigated.

Based on the foregoing, upon automatic kill of certain of the screened C4s which have been found to be defective, the inspection is completed (Box 54) and the screening of defective C4s is subjected to a validation analysis.

Using a validation analysis strategy, there may be utilized a die which is rejected from the ES limit activity and which will characterize a high volume failure versus die location and an algorithm may be generated for manufacturing reject decisions.

The structure may be modified to allow for multiple metrology criteria at various limits based on input grouping of C4 connections, in addition to a current capability for redundant non-critical or critical bump designations.

The specifications may define the size limits by groupings, customer and/or BA development, and relationships between the critical metrology inspections or parameters may be defined by either diameter, height, volume and spacing proximity between the C4 connections, in effect, either more rigidly for critical or closely spaced C4s or looser standards for isolated C4s.

In this connection, illustrated in FIG. 6 is a performance graph representing C4 spacing to be considered to be more critical than widely spaced apart C4 connections. From the foregoing, it becomes possible to then implement appropriate metrology criteria to the particular spacing for the respective C4 connections.

While the present invention has been particularly shown and described with respect to preferred embodiments thereof, it will be understood by those skilled in the art that the foregoing and other changes in forms and details may be made without departing from the scope and spirit of the present invention. It is therefore intended that the present invention not be limited to the exact forms and details described and illustrated, but fall within the scope of the appended claims.

1. A method for employing apparatus defining multiple metrological criteria for the screening of defects in electrical connections comprising:
providing a plurality of electrical connections arrayed in mutually spaced relationships on a substrate;
defining at least one first dimensional surface region on said substrate enclosing first said electrical connections;
defining at least one further dimensional surface region enclosing other said electrical connections externally of said first dimensional surface region;
screening said first electrical connections for defects by applying a first metrological criterion which defines a minimum permissible spacing between adjacently located said electrical connections;
screening said other said electrical connections for defects by applying at least one further metrological criterion which differs from said first metrological criterion, a plurality of said electrical connections being arrayed within predetermined perimeters, each said perimeter being defined by a respective said dimensional surface region; and
wherein screening of said electrical connections for defects which are located externally of the at least one first and at least one further dimensional regions is implemented with the application of metrological criteria which differs from the first and at least one further metrological criterion.

2-3. (canceled)

4. (canceled)

5. A method as claimed in claim 1, wherein each said perimeter encompassing a predetermined number of said electrical connections defines a hypothetical circular area.

6. A method as claimed in claim 1, wherein each said perimeter encompassing a predetermined number of said electrical connectors defines a hypothetical box-shaped area.

7. A method as claimed in claim 1, wherein the metrological criterion for said first electrical connections sets forth more stringent requirements than the metrological criteria for the electrical connections located externally of said first dimensional region.

8. A method as claimed in claim 7, wherein each said electrical connection comprises a controlled collapse chip connection (C4).

9. A method as claimed in claim 8, wherein said C4s are inspected according to said metrological criterion for height, volume and diameter.

10. A method as claimed in claim 1, wherein said screening defines an automatic elimination of electrical connections which are found to be defective during screening thereof.

11. A system including an arrangement employed for defining multiple metrological criteria for the screening of defects in electrical connections which are arrayed in mutually spaced relationships on a substrate;
at least one first dimensional surface region on said substrate enclosing first said electrical connections;
at least one further dimensional surface region enclosing other said electrical connections externally of said first dimensional surface region;
a screening arrangement which screens said first electrical connections for defects by applying a first metrological criterion, which defines a minimum permissible spacing between adjacently located said electrical connections;
said other said electrical connections being screened for defects by applying at least one further metrological criterion which differs from said first metrological criterion, a plurality of said electrical connections being arrayed within predetermined perimeters, each said perimeter defined by a respective said dimensional surface region; and
wherein screening of electrical connections for defects which are located externally of the at least one first and at least one further dimensional regions is implemented with the application of metrological criteria which differ from the first and at least one further metrological criterion.

12-13. (canceled)

14. (canceled)

15. A system as claimed in claim 11, wherein each said perimeter encompassing a predetermined number of said electrical connections defines a hypothetical circular area.

16. A system as claimed in claim 11, wherein each said perimeter encompassing a predetermined number of said electrical connectors defines a hypothetical box-shaped area.

17. A system as claimed in claim 11, wherein the metrological criterion for said at least one electrical connection sets forth more stringent requirements than the metrological criteria for the electrical connections located externally of said first dimensional surface region.

18. A system as claimed in claim 17, wherein each said electrical connection comprises a controlled collapse chip connection (C4).

19. A system as claimed in claim 18, wherein said C4s are inspected according to said metrological criterion for height, volume and diameter.

20. A system as claimed in claim 11, wherein said screening effectuates an automatic elimination of electrical connections which are found to be defective during screening thereof.
